(19) United States
(12) Patent Application Publication
(10) Pub. No.: US 2013/0152680 A1
(43) Pub. Date: Jun. 20, 2013

(54) ATOM-BASED ACCELEROMETER

(71) Applicants: Charles Sackett, Charlottesville, VA (US); Mary Salit, Plymouth, MN (US); Kenneth Salit, Plymouth, MN (US); Robert Compton, Plymouth, MN (US)

(72) Inventors: Charles Sackett, Charlottesville, VA (US); Mary Salit, Plymouth, MN (US); Kenneth Salit, Plymouth, MN (US); Robert Compton, Plymouth, MN (US)

(73) Assignee: HONEYWELL INTERNATIONAL INC., Morristown, NJ (US)

(21) Appl. No.: 13/327,294

(22) Filed: Dec. 15, 2011

(51) Int. Cl. G01P 15/00

(52) U.S. Cl. 73/488

(57) ABSTRACT

An atom-based accelerometer for measuring acceleration or gravity with an interaction region less than a millimeter in size. An exemplary device includes a magnetic double-well trap produced on a chip. Creation and dissolution of the double-well trap is provided by interaction between an ac magnetic field and a radio frequency (rf) magnetic field produced by traces on the chip.

### BACKGROUND OF THE INVENTION

The best rate gyros currently commercially available are based on the optical Sagnac effect, which takes place either in an active laser cavity or in a passive fiber interferometer. In the first case, the products are known as gyrolasers and, in the second, fiber-optic gyros (FOGs). The replacement of the optical waves by matter waves leads to a huge gain in sensitivity, even if the latter is, in part, counterbalanced by the reduction in the signal-to-noise ratio and in the area of the interferometer. Matter-wave gyros have been an experimental reality since 1997, the date of the first measurement of the Earth's rotation with this type of device. Today, several laboratories have constructed similar sensors, and the performances attained already surpass those of the best optical gyros. For future developments, the potential for improvement is still several orders of magnitude. Atom-interferometric accelerometers and gravimeters currently achieve nano-g resolutions with sub-nano-g bias stabilities.

Atom rate gyros rely on the use of matter waves. According to the laws of quantum mechanics, matter waves are associated with any particle that has mass. The technique of atom interferometry allows phase differences between packets of matter waves to be measured. It requires, in particular, the prior cooling of the atoms to temperatures close to absolute zero, in order to limit their thermal velocity dispersion. The cooled atoms are called cold or ultracold atoms.

Significant efforts have been deployed in recent years in order to integrate part of the functions for trapping, cooling and manipulating cold atoms onto chip devices that are compact, but also have very good control of the magnetic fields necessary for the system and a relatively low electrical power consumption. In addition, the advantage of using and of incorporating radio frequency fields for the coherent manipulation of the atoms has recently been experimentally demonstrated by the coherent separation into two equal parts of a Bose-Einstein condensate in 2006, which constitutes the atom equivalent of a separator plate for a laser, a key component for the construction of atom interferometers.

However, Atom-interferometric accelerometers applications are limited by the size, weight, and power of the apparatus. The active region in the best such devices is over a meter in length.

### SUMMARY OF THE INVENTION

The present invention allows an atom-inerferometric measurement of acceleration or gravity with an interaction region less than a millimeter in size. The present invention provides an atom-based accelerometer, using a magnetic double-well trap produced on an atom chip.

Atoms which are confined in a potential well with a zero average velocity during sensing can have long interaction times in small sensing regions. The present invention keeps the atoms confined during interrogation. The present invention also uses radio frequency (rf) rather than optical fields to split the atomic wavefunctions, leading to long coherence times and low noise relative to other chip-based interferometers.

An atomic Bose-Einstein condensate is prepared and confined in a single-well trap. By applying an appropriate radio-frequency field, the trap can be split into two wells, with each atom having equal probability of being located in each well.

The atoms are held in their magnetic trap at the location of the (non-zero) magnetic field minimum, where their potential energy is lowest. Applying a linearly polarized rf field at a frequency which is nearly resonant for atoms at the center of the trap increases the potential energy associated with that location, so that it is no longer a minimum, but toward the edges of the trap, the larger magnetic field magnitude shifts the atomic states so that the rf field is not near resonance. In this way, the rf raises the potential energy at the center of the trap but does not affect the edges significantly. In addition, when the RF magnetic field is not perpendicular to the local DC field, it does not interact strongly with the atoms, and the potential energy associated with the interaction is reduced. At the center of the trap, the RF and DC magnetic fields are perpendicular. Along one axis the DC field direction is approximately constant as distance from the trap center increases and they remain nearly perpendicular over the relevant length scales. Along another axis the DC field direction changes, but direction into which it begins to point is also perpendicular to the RF magnetic field. Along the third axis, however, the DC magnetic field rapidly becomes more and more parallel to the RF magnetic field with distance from the trap center. Along that axis the interaction with the RF field falls off very sharply, since both the direction and the magnitude of DC the magnetic field are changing in such a way as to reduce it, and the potential energy has two deeper minima a short distance on either side of the trap center. Instead of forming a spherical shell, the atoms are trapped in these deepest potential minima, separated along the direction of the RF magnetic field.

The atoms are held in the wells for a measurement time T, during which each of the component wave packets develops a quantum phase.

The difference between the phases is proportional to any acceleration experienced by the system along the line connecting the two trap centers. After the measurement, the atoms are released, allowing them to fall and ballistically expand until the packets overlap. Interference between the two sources produces a standing-wave pattern in the resulting density distribution. By measuring the location of the nodes and anti-nodes, the relative phase can be determined, and with it the acceleration component.

In one embodiment, this measurement is made by a camera mounted with a view of the trapping region with high magnification. In another embodiment, a laser beam passes through a part of the re-united atom cloud. A small (e.g., single-pixel) detector located opposite a laser drive measures the fraction of the laser light which is absorbed by the atoms. In another embodiment, a standing wave pulse is transmitted to the trapping region. The frequency of the standing wave pulse is designed to line up with the atomic interference pattern. A phase shift in the atomic interference pattern then causes scattering of the standing wave. The scattering is detected either as a reduction of intensity in that field or with a camera or detector as an increase in scattered light. In another embodiment, an optical cavity is placed around a portion of the atom cloud. The presence or absence of atoms in the optical cavity shifts the resonance frequency of the cavity and alters the output intensity. Other techniques including non-optical sensors may be used.

### BRIEF DESCRIPTION OF THE DRAWINGS

Preferred and alternative embodiments of the present invention are described in detail below with reference to the following drawings:

FIGS. 1 and 2 are block diagrams of an exemplary system formed in accordance with an embodiment of the present invention;

FIG. 3 is a flow diagram of an exemplary process performed by the system shown in FIG. 1;

FIG. 4 is a cross-sectional view of a trap area on a chip formed in accordance with an embodiment of the present invention;

FIG. 5 is a top view of the chip of FIG. 4 with an optical sensor; and

FIG. 6 is a partial zoom view of the chip of FIG. 5 at the trap area.

### DETAILED DESCRIPTION OF THE INVENTION

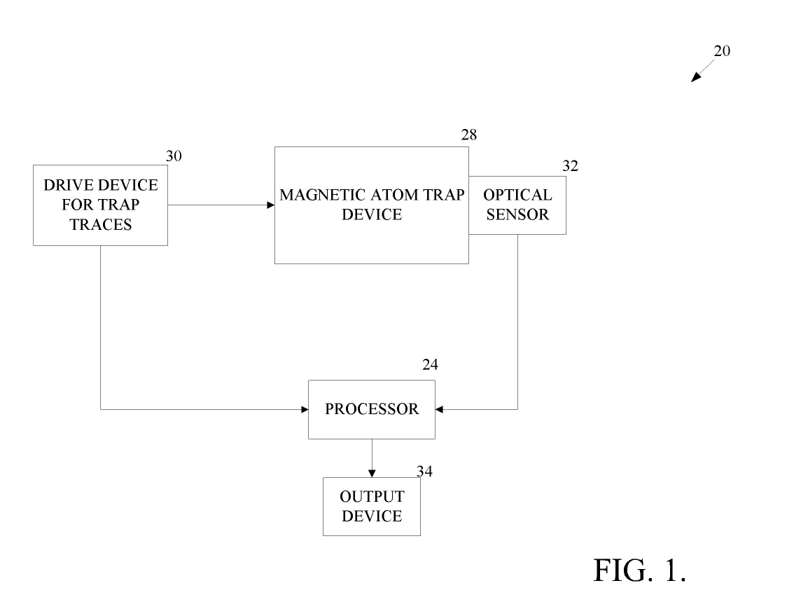

As shown in FIG. 1, an atom-based accelerometer 20 includes a magnetic atom trap device 28 located at least partially within a vacuum. The atom-based accelerometer 20 also includes an optical sensor 32, a processor 24, a drive device 30 and an output device 34.

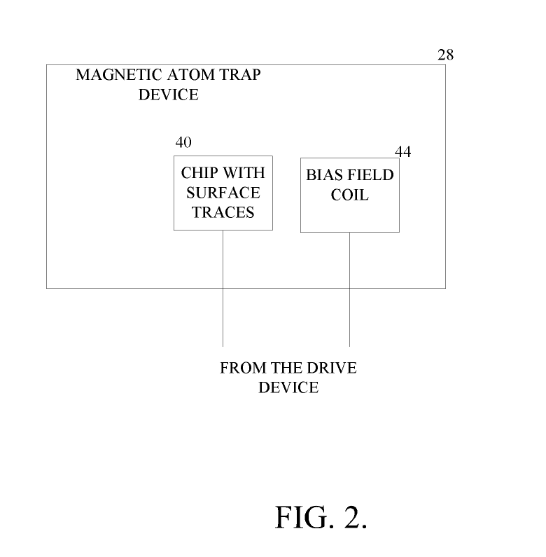

The drive device 30 applies radio frequency (rf) current (signal) and/or an alternating current (AC) to traces on a chip 40 within the trap device 28 according to instructions from the processor 24 (FIG. 2). Atoms are manipulated by magnetic fields produced by the traces. At a certain point in time, the optical sensor identifies a phase of the atoms then the processor 24 determines an acceleration (or ΔV) value based on the phase of the atoms and sends the results to the output device 34.

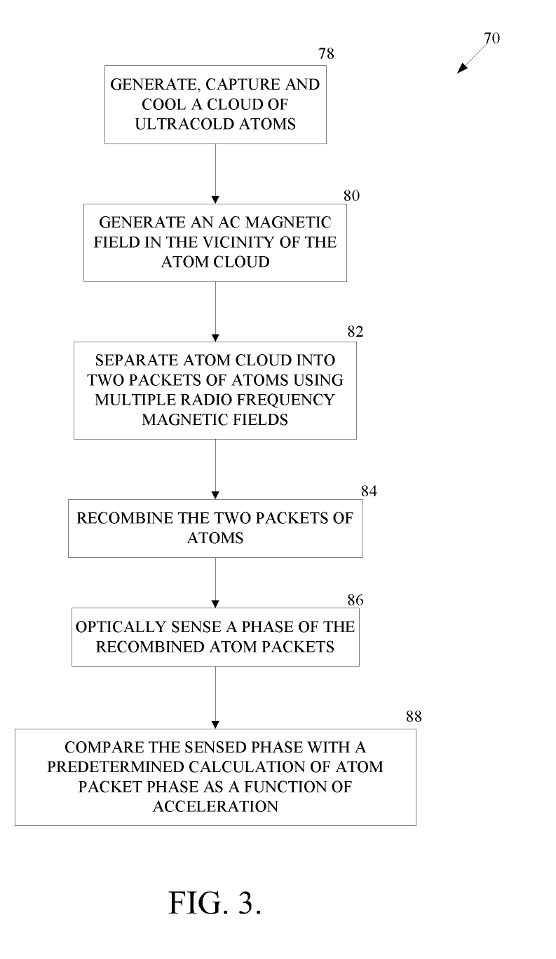

FIG. 3 shows an exemplary process 70 performed by the atom-based accelerometer 20. First an atomic Bose-Einstein condensate is prepared from a cold atom sample collected and storied in a Magneto Optical Trap (MOT) using methods which have been previously published and are known to one with skill in the art. The MOT may be formed near the surface of the chip 40 (as in a Mirror MOT) or may be formed some distance away and transferred to the location of the chip using magnetic and optical forces. Cold atoms once collected near the chip surface are confined in a single-well trap according to magnetic fields produced by the AC current in one or more traces on the chip 40 (blocks 78, 80). The temperature of the sample can then be further reduced by means of “evaporative cooling,” another technique known to one with skill in the art and described in published works. Evaporative cooling typically requires RF fields to be applied to the atoms in the magnetic trap to alter the magnetic moment of those atoms with the greatest thermal energy in such a way as to allow them to escape the trap, thus reducing the temperature of the remaining sample until it reaches a critical threshold and a Bose Einstein Condensate is formed. Then, the single-well trap is split into two wells by applying a field generated by a second rf current (block 82). By design each atom has an equal probability of being contained in either well. The atoms are held in the two wells for a predefined amount of time T, during which each of the component wave packets (i.e., well of atoms) develops a quantum phase dependent on the acceleration of the chip.

After a time (the ideal duration of which is determined by magnitude and frequency of acceleration changes one expects to measure) the RF field which divides the two potential wells is turned off. Interference between the two groups of atoms produces a standing-wave pattern in the resulting density distribution. Then, at a block 86, the optical sensor 32 images this interference pattern and measures the location of nodes and anti-nodes to determine the relative phase between nodes and anti-nodes. The interference pattern may be magnified for easier optical detection by turning off the AC confining fields and allowing the atoms to fall and ballistically expand until the packets overlap (block 84), but other embodiments are possible in which the phase is measured in situ without ballistic expansion. The processor 24 then determines the acceleration along the line connecting the two trap centers based on the determined relative phase between nodes and anti-nodes, at block 88.

Thus with the single accelerometer 20, acceleration sensing is not continuous due to the time required to perform the process 70. In one embodiment, continuous operation is achieved with the use of multiple accelerometers 20 that are timed to provide overlapping measurements. These devices may or may not be co-located on a single substrate.

Multiple devices might also be used to extend the dynamic range of this type of sensor. The greater the separation between the atom clouds, the greater the phase shift a given acceleration causes. However, an acceleration causing a phase shift of, eg, 4.1*Pi is indistinguishable from one causing a shift of 2.1*Pi or 4000.1*Pi. So with a single sensor, accelerations that causing phase shifts greater than 2*Pi introduce ambiguity. That implies a trade off between resolution and dynamic range, since decreasing the separation distance to allow for unambiguous measurement of large accelerations reduces the resolution with which small accelerations can be measured.

This can be avoided through the use of an array of the double-wells, each of which separates the clouds by different amounts. The one which separates the clouds by the smallest distance would give the least precise measure of small accelerations, but would not have phase ambiguities caused by readings greater than 2*Pi for larger accelerations. The one with the next-smallest separation might go over 2*Pi in a large acceleration, but the resulting ambiguity can be resolved with the aid of readout from the first device, which would be consistent with only one of the possible values implied by the second. Incorporating a third device which wells an even greater distance allows for yet higher resolution, and first two measurements sufficiently resolve the ambiguity on that read out. This idea, similar to that of a Vernier scale, can be extended to as many devices as are required to span the desired dynamic range and resolution.

This concept is useful for atom interferometric devices, but most such devices are not quite as amenable to miniaturization as this one, and so the possibility of including multiple sensors is more daunting.

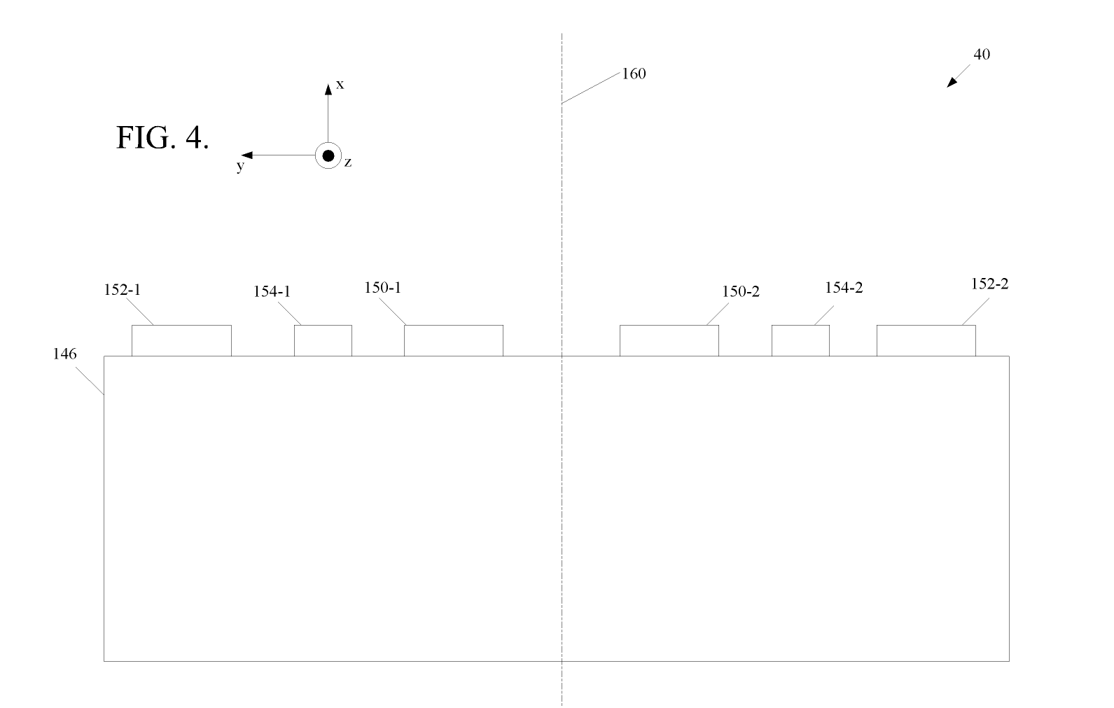

FIGS. 4-6 show the chip 40 which includes a substrate 146 with deposited metal traces 150-1, 150-2, 152-1, 152-2, 154-1, 154-2. The traces 150-1, 150-2, 152-1, 152-2, 154-1, 154-2 are parallel in a trap region 164, which is approximately in the center of the substrate 146. The traces 150-1, 150-2, 152-1, 152-2 receive a low frequency ac current (eg 10 kHz) from the drive device 30 to produce a linear quadruple field. The traces 154-1, 154-2 receive a high frequency (rf) current. The current in the traces 150-1 and 152-2 travels in the same direction. The current in the traces 150-2 and 152-1 travels in the opposite direction as the other traces. The rf current in the traces 154-1, 154-2 travels in the same direction.

The magnetic fields generated by the traces 150-1, 150-2, 152-1, 152-2 captures the atoms into a single packet. The introduction of the magnetic fields produced by the traces 154-1, 154-2 causes the creation of two wells that split the single packet atoms into two packets.

Higher order perturbations to the trap fields scale with the separation of the traces. Absolute geometry errors will have a smaller relative effect if the traces are more distant. In order to provide more accurate operation, the trace separation is at least somewhat larger than the separation between the two packets, since otherwise higher order corrections will be large.

The dotted line 160 shows the trap symmetry line x=0. The arrows show the directions of the currents. The currents are shown in series, requiring an additional connecting loop which is located far enough from the trap for the magnetic field due to it to be negligible. Separations between the traces 150-1, 150-2, 152-1, 152-2, 154-1, 154-2 (170, 174, 176) provide optimum quadrupole amplitude and rf uniformity for a given center-wire spacing.

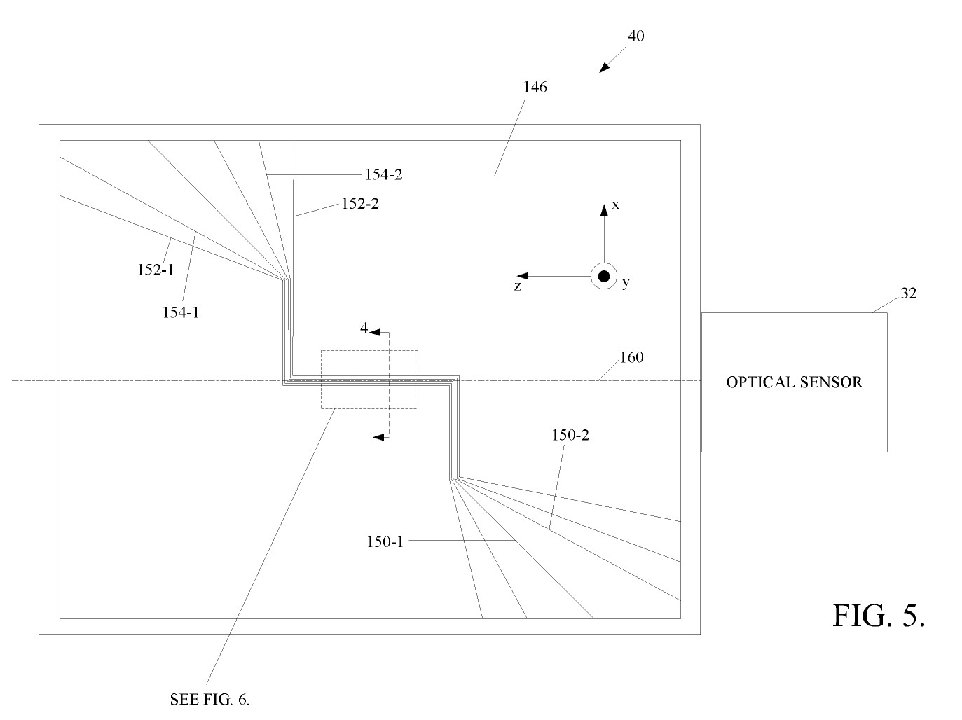

The difficulty with large trace separations is that they require more current to generate the same fields. Additional traces (shown in FIG. 5) for z-confinement are achieved with ‘Z’ bends a suitable distance from the trap center. The spacings are shown in terms of the length scale between the center axis 160 and the inner trace, a 170. The locations of the outer traces 152-1, 152-2 provide the maximum possible trapping gradient. The combination of the fields due to these traces produces a zero line located a distance y_{c}=2.41a below the chip surface, with

[symbol]

The above rf trace separation was chosen to null the rf gradient at y_{c}, in order to minimize the effects of the β perturbation. It provides a field amplitude

[symbol]

In one embodiment, achieving the target amplitude of 30 G for a=1 mm would require a current of 18 A.

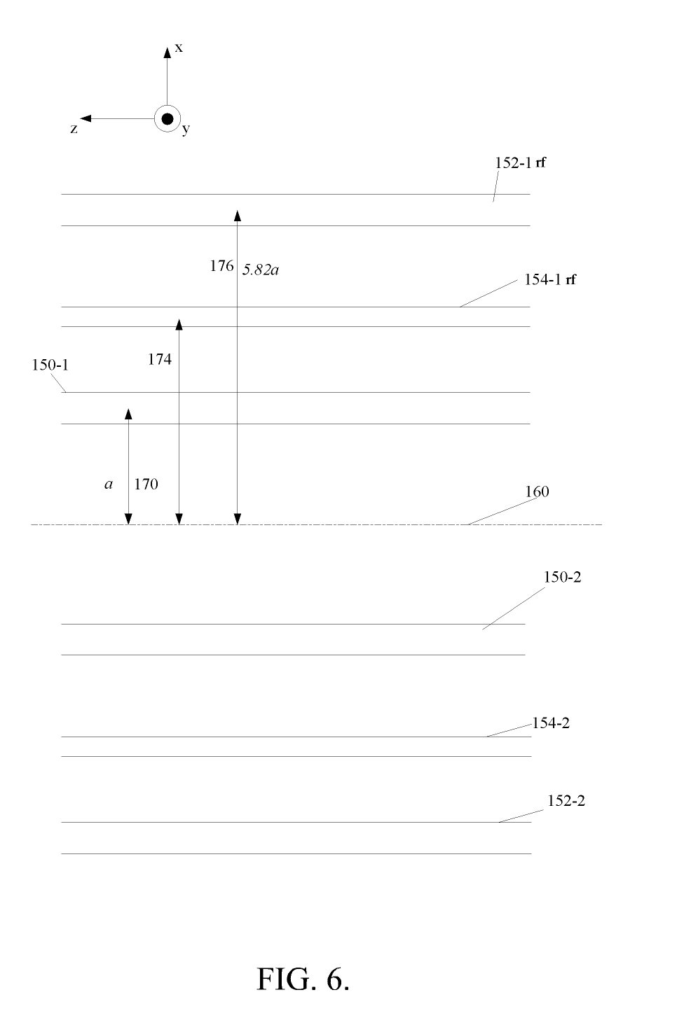

The geometry of FIG. 6 was chosen to maximize the dc gradient and minimize the rf gradient at the quadrupole zero position y_{c}. More properly, this optimization should be performed at the position of the atoms, which will be offset from y_{c} due to gravity. In one embodiment, the actual trapping potential is used when designing the pattern of the traces.

Lastly, a bias field along z is required to maintain the magnetic orientation of the atoms. The bias field is implemented using an external coil pair 44 (FIG. 2) in a Helmholtz configuration. A dc trap would require highly accurate alignment of the external field to the chip axis, but by using ac currents this concern is alleviated.

If field fluctuations cause ΔV≡V(x₀, y₀)−V(−x₀, y₀) to vary, this will induce a differential phase shift that could mask small accelerations. For the parameters above,

14 MHz. In comparison, an acceleration of 35 ng shifts mHz. Thus, differential noise of 10⁻⁹ relative amplitude is sufficient to overwhelm the fundamental limit from phase diffusion. Fortunately, the rf trapping method is inherently quite symmetric.

The effect of weak field imperfections can be analyzed. If there is a static perturbation β₀a(r), and an rf field perturbation β_{rf}a(r), the perturbation to the potential is

[symbol]

Where [symbol] , and

[symbol]

Similarly,

In order to have δV be non-symmetric in x, a non-symmetric current distribution is required. If the dc current distribution is perfectly odd in x, then a will contribute no asymmetry AV. If the rf current distribution is perfectly even, there will be no ΔV. Thus, if the conducting traces on an atom chip were laid out symmetrically and driven in series with the appropriate currents, a perfectly symmetric trap would result.

In practice, trap asymmetry will be important only to the extent that it fluctuates: a constant asymmetry between the two traps could be measured and calibrated out. Noise in the trapping fields will be produced by fluctuations in the drive currents, and the degree of geometrical symmetry required depends on the stability of the current sources. For instance, obtaining a relative trap imbalance of 10⁻⁹ could be achieved using conductors placed accurately to 10⁻³ precision, along with drive currents stable to 10⁻⁶.

A major exception to this conclusion is the effect of external fields. It can be expected that a significant external dc field will be present, and a constant aₓ component does contribute to ΔV, giving a term of order μ_{F}B₁Bₑₓₜx₀/B₀ for Bₑₓₜ=B₀aₓ. To maintain ΔV below mHz for the proposed trap configuration would require Bₑₓₜ 1 μG. This could be achieved through magnetic shielding.

the present invention modifies the trapping field to remove the dc sensitivity. This is achieved through a variation on a time-orbiting potential (TOP) technique. Here, instead of a dc linear quadrupole, an ac field is used instead,

B_{quad}=B₁(x−y)

with an oscillation frequency Ω is that is small compared to the spin resonance μ_{F}B₀/, but large compared to the atomic motional frequencies ωᵢ. In this case, the spins will adiabatically follow the changing field, while the atomic motion will experience a time-averaged potential. The effect of the rf field does not depend on the sign of the dc field, so the double-well geometry is unchanged.

Working out the required time averages in the quartic expansion gives [symbol] C

[symbol]

This requires slightly larger field amplitudes, with B₁>150 G/cm needed to achieve splitting at B₀=B_{rf}. A set of functional parameters is B₁=300 G/cm, B₀=B_{rf}=30 G, which gives x₀=0.58 mm, y₀=0.41 mm, ωₓ=2×38 Hz, and ω_{y}=2×20 Hz. Accelerometer performance would be comparable to that of a dc configuration, with the advantage of noise-immunity to dc fields.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
at an atom accelerometer in a vacuum,
generating, capturing and cooling a cloud of ultracold atoms;
generating an alternating current (AC) magnetic field with a trapping region that represents a local field minimum in three dimensions;
separating the atom cloud into two spatially displaced packets of atoms using radio frequency (rf) magnetic fields,
allowing the two packets to be recombined into a single atom cloud;
at a sensor measuring a phase of recombined single atom cloud after recombination; and
at a processor generating an acceleration value based on the measured phase.

2. The method of claim 1, wherein measuring comprises optically measuring.

3. The method of claim 2, further comprising electrically monitoring and controlling the trapping and splitting fields to optimize that optical measuring.

4. The method of claim 1, wherein generating an acceleration value is further based on an estimated phase value.

5. An accelerometer device comprising:
a substrate located at least partially within a vacuum, the substrate comprising:
an atom sources configured to generate and cool a cloud of atoms;
at least one first trace configured to generate an alternating current (AC) magnetic field thereby trapping the cloud of atoms in a trapping region;
at least one second trace configured to generate a radio frequency (rf) magnetic field, thereby separating the atom cloud into two spatially displaced packets of atoms;
a sensor configured to measure a phase of a single atom cloud after recombination occurs after atom cloud separation; and
a processor configured to generate an acceleration value based on the measured phase.

6. The device of claim 5, wherein the sensor comprises an optical sensor.

7. A method comprising:
at an atom accelerometer in a vacuum,
generating, capturing and cooling a cloud of ultracold atoms;
generating an array of magnetic traps using alternating current (AC) magnetic fields with multiple trapping regions that represents multiple local field minima in three dimensions;
separating the atom cloud into two spatially displaced packets of atoms using radio frequency (rf) magnetic fields, wherein the displacement is into traps with each trap displacing the packets by a different amount;
allowing the two packets in each trap to be recombined into a single atom cloud;
at a sensor measuring a phase of recombined single atom cloud after recombination; and
at a processor generating an acceleration value based on the measured phase inferred from the readout of the trap with the greatest separation distance, with any ambiguity in this phase resolved by the readout of the other traps.
